(19) United States
(12) Patent Application Publication
(10) Pub. No.: US 2007/0204220 A1
(43) Pub. Date: Aug. 30, 2007

(54) RE-LAYOUT OF NETWORK CONTENT

(75) Inventors: Radoslav Petrov Nickolov, Bellevue, WA (US); Charles E. Jacobs, Seattle, WA (US); Patrice Y. Simard, Bellevue, WA (US); Kevin Gjerstad, Kirkland, WA (US); Michael S. Cooper, Seattle, WA (US)

Correspondence Address: AMIN. TUROCY & CALVIN, LLP, 24TH FLOOR, NATIONAL CITY CENTER, 1900 EAST NINTH STREET, CLEVELAND, OH, 44114, US

(73) Assignee: MICROSOFT CORPORATION, Redmond, WA (US)

(21) Appl. No.: 11/461,699

(22) Filed: Aug. 1, 2006

Related U.S. Application Data
(60) Provisional application No. 60/776,973, filed on Feb. 27, 2006.

(51) Int. Cl. G06F 17/00

(52) U.S. Cl. 715/530; 715/531; 715/529; 715/517; 715/525; 715/520

(57) ABSTRACT

Techniques for modifying network content layout to be presented by an application are disclosed. More specifically, the content layout or portions thereof can be altered to facilitate specific tasks including, but not limited to, enhancing readability. For example, content can be laid out in one or more discrete areas and navigation enabled in unique sequential and/or non-sequential manners. Further yet, content can be modified, moved and/or removed, among other things. This functionality can be executed automatically or upon specific instruction, for instance as specified by a user, content provider or third party service.

### CROSS-REFERENCE TO RELATED APPLICATION

This application claims the benefit of U.S. Provisional Application No. 60/776,973, filed Feb. 27, 2006 and entitled “LAYOUT MODIFICATION OF WEB CONTENT.” The entirety of this application is incorporated herein by reference.

### BACKGROUND

Since its very inception, the World Wide Web's capability to convey information has been essential to its explosive growth. Today, HTML (HyperText Markup Language) content on the web is increasingly becoming the leading source of information for users. As a result, reading increasingly takes place on the web.

HTML rendering engines and Web browsers have been available since the late 1990's offering a universally accessible publishing medium. A rendering or layout engine is software that acquires web content such as HTML as well as formatting information and facilitates display of the formatted content on a screen. The rendering engine is typically employed by web browsers and other applications that require displaying and/or editing of web contents. Over the years, HTML rendering engines have grown to include sophisticated typographic and layout capabilities. Simultaneously, web browsers expose rich programming models that give developers access to these capabilities, and the means to integrate client plug-ins with access to the browser's object model.

While such browser capabilities have been utilized to enhance the overall look and feel of web pages, the readability of network content such as HTML text has remained poor. For example, reading a long stream of text conventionally involves continually scrolling down a web page. This can be a navigational challenge for the user. Combined with a computer's form factor specifics, the difficulty of navigation results in user fatigue and loss of attention, which limits the amount of text content they are able to read effectively.

### SUMMARY

The following presents a simplified summary in order to provide a basic understanding of some aspects of the claimed subject matter. This summary is not an extensive overview. It is not intended to identify key/critical elements or to delineate the scope of the claimed subject matter. Its sole purpose is to present some concepts in a simplified form as a prelude to the more detailed description that is presented later.

Briefly described, the subject innovation pertains to modification of network content layout or re-layout. Systems and methods are provided herein to facilitate acquiring network content (e.g., HTML . . . ) and modifying the layout thereof. The layout can be altered to facilitate specific tasks including but not limited to reading of document content. By way of example, the system can alter text styles (e.g., font, size, bold, italicize, underline . . . ), divide content into disparate regions and/or pages, move, modify and/or remove content, amongst other things. As a result, users are able to more effectively navigate and/or comprehend network content than conventionally possible.

In accordance with one particular aspect of the innovation a user interface is provided that can facilitate interaction with content. In one instance, the interface can enable selection/identification of content for modification. Additionally or alternatively, layout preferences can be set and associated with particular content or types of layouts to facilitate automatic re-layout.

While the innovation can be solely user centric, according to another aspect of the subject innovation modification can be controlled and/or influenced by content providers and/or third parties. Further yet, it should be appreciated that context can also affect if, how and when re-layout will be performed.

To the accomplishment of the foregoing and related ends, certain illustrative aspects of the claimed subject matter are described herein in connection with the following description and the annexed drawings. These aspects are indicative of various ways in which the subject matter may be practiced, all of which are intended to be within the scope of the claimed subject matter. Other advantages and novel features may become apparent from the following detailed description when considered in conjunction with the drawings.

### BRIEF DESCRIPTION OF THE DRAWINGS

FIG. 1 is a block diagram of a layout modification system.

FIG. 2 is a block diagram of a layout modification component.

FIG. 3 is an exemplary screenshot of a conventional web page.

FIG. 4 is an exemplary screenshot of a web page modified in accordance with an aspect of the subject innovation.

FIG. 5 is an exemplary screenshot of a web page modified in accordance with an aspect of the subject innovation.

FIG. 6 is a block diagram of a layout modification system including a user interface.

FIG. 7 is a block diagram of a layout modification system including an analysis component.

FIG. 8 is a block diagram of a layout modification system.

FIG. 9 is a flow chart diagram of a re-layout method.

FIG. 10 is a flow chart diagram of an automated layout modification methodology.

FIG. 11 is a schematic block diagram illustrating a suitable operating environment for aspects of the subject innovation.

FIG. 12 is a schematic block diagram of a sample-computing environment.

### DETAILED DESCRIPTION

Presented herein is a technology that enhances navigation and/or comprehension of arbitrary network content. Aspects of the innovation enable users to control content presented by a browser or like mechanism. More particularly, although not limited thereto, an application targeting improved layout of content such as HTML text is disclosed. By way of example, text size, line spacing, and margins may be augmented. Furthermore, text can be reformatted into columns and/or paginated. Control or interaction can take many forms including, without limitation, explicit content selection and layout specification, user/content provider preferences and style associations. The identified functionality can be embodied within a toolbar, plug-in, injected programmatic script and/or third party service, among other things.

Various aspects of the subject innovation are now described with reference to the annexed drawings, wherein like numerals refer to like or corresponding elements throughout. It should be understood, however, that the drawings and detailed description relating thereto are not intended to limit the claimed subject matter to the particular form disclosed. Rather, the intention is to cover all modifications, equivalents and alternatives falling within the spirit and scope of the claimed subject matter.

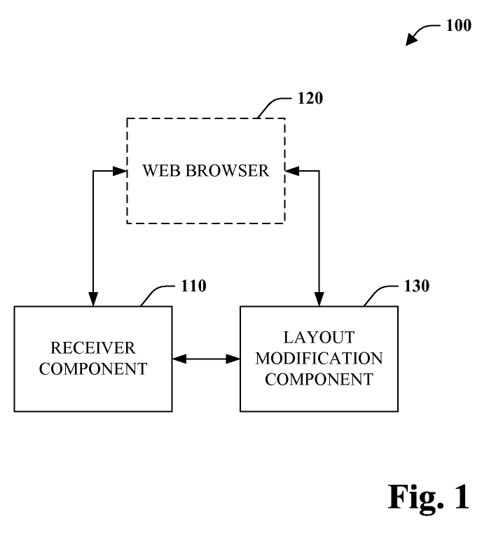

Referring initially to FIG. 1, a content modification system 100 is illustrated in accordance with an aspect of the subject innovation. The system includes a receiver component 110 that receives, retrieves, or otherwise obtains or acquires network content. For example, the receiver component 110 can obtain web content such as text and graphics (e.g., specified in HTML, XAML . . . ), amongst other things, from web browser or viewer 120, which renders or presents web pages or more generally web content to users. It is also to be noted that additional context information such as the size of the viewable region and/or a particular task or goal of interest, among other things, may also be received or obtained by the receiver component 110, for example from web browser 120 and/or a separate context collecting and/or aggregating component (not shown). The acquired web content as well as additional information can be transferred to or made accessible by layout modification component 130.

The layout modification component 130 can modify the layout of network content to facilitate specific tasks. In one instance, the task may relate to enhancing the readability of web content. It is to be appreciated, however, that the innovation is not limited thereto and alternate tasks/goals are contemplated and to be considered within the scope of the innovation. For purposes of clarity and understanding, the layout modification component 130 can apply typographical and/or layout principles to enhance the readability of a stream of text given a viewable region, for instance. By way of example, excessively large text line width can be avoided by using multiple columns; text size can also be adjusted as well as line spacing margins and inter-column spaces, among other things. The layout modification component 130 can provide altered web content to the web browser 120 for display, which can correspond to all or a portion of the original content. Conventional readability barriers can thus be removed allowing users to both spend more time reading using their web browsers and be more productive.

As will be appreciated by those in the art, system 100 can be implemented in a myriad of manners all of which are to be considered within the scope of the appended claims. By way of example and not limitation, the functionality of the receiver and layout modification components 110 and 130 can form at least part of a web browser plug-in, toolbar and/or other application. In this manner, a user may be in control of what content is modified and how, for instance based on settings and/or preferences. Alternatively, such functionality can be provided via a script embedded in a web page by a user, author or content provider. In addition to user control or as an alternative, authors and/or content providers can control or direct re-layout in a manner beneficial to them. For instance, content can be modified in a way that ensures that advertisements are not completely excluded from view. Additionally or alternatively, the re-layout functionality can be performed by a third party service, for instance by injecting script into a web page, among other things.

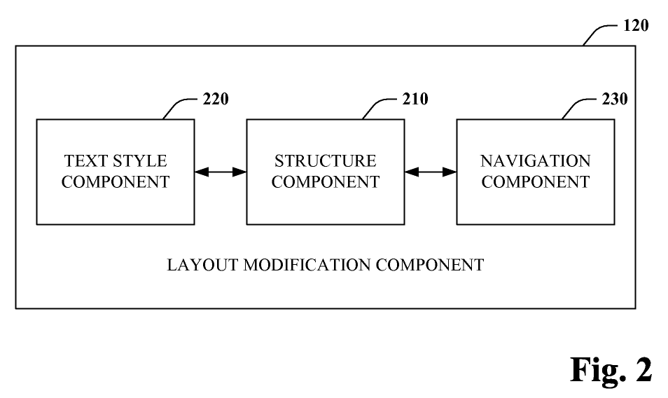

Turning attention to FIG. 2, an exemplary implementation of the layout modification component 120 is illustrated in accordance with an aspect of the subject innovation. As depicted, the layout modification component 120 can include structure component 210, text style component 220 and navigation component 230 communicatively coupled together.

The structure component 210 analyzes content with respect to various factors such as the size of display and/or goal of modification and is operable to break a presentation up into areas and lay out content in those areas. By way of example and not limitation, the presentation, such as a web page, can be divided and laid out in columns. A multi-column layout enables both rich combinations of text and graphics, and enhanced readability by constraining line lengths within limits optimal for reading. Accordingly, stucture component 210 can alter the layout by repositioning blocks of flowing text and/or graphical objects. Additionally, note that rather than simply repositioning structure component 210 can also remove items such as graphical objects, for example, in scenarios where it enhances readability or otherwise facilitates a particular task.

The text style component 220 can reformat the style of content text. For example, component 220 can alter font, size, color and text background amongst other text attributes (e.g., bold, italics, underline . . . ). These text style changes can be made in response to user or content provider settings as further described infra, and/or in response to changes dictated by other components such as the structure component 210 and/or navigation component 230. For instance, the text style component 220 can modify the text size where text is to be positioned into multiple columns of limited space.

The navigation component 230 is operable to divide and disperse content across multiple pages and/or portions thereof. In other words, the navigation component 230 can break page content down into separate page loads on the same or different pages. Accordingly, navigation is not limited to sequential page navigation such as scrolling. Further yet, specific content can be shown or hidden on a single page (or multiple pages) such as but not limited to illustrations ads, related links, or other contextual information.

For example, reading a long stream of text content presents a navigational challenge for a user thereby hindering readability. Conventionally, web browsers use scrolling only for content navigation. As the displayed portion of content changes, the users need to keep track of the last text they read in order to continue after scrolling. This interrupts the reading experience and in practice limits the amount of scrolling content users can effectively consume. Accordingly, the navigation component 230 is introduced to, among other things, eliminate scrolling and generate multiple web pages of content. Like a book, after one page has been read the user can flip to the next page and begin reading were he/she left off. Additionally, the navigation component 230 facilitates in-place pagination such that the content can be switched from scrolling to paginated behavior within elements or portions of a layout.

The layout modification component 120 can employ one or more of structure component 210, text style component 220 and navigation component 230 to facilitate readability, for instance. Furthermore, it is to be appreciated that other components (not shown) that apply alternate typographical and/or layout principles can also be utilized alone or in conjunction with those previously described.

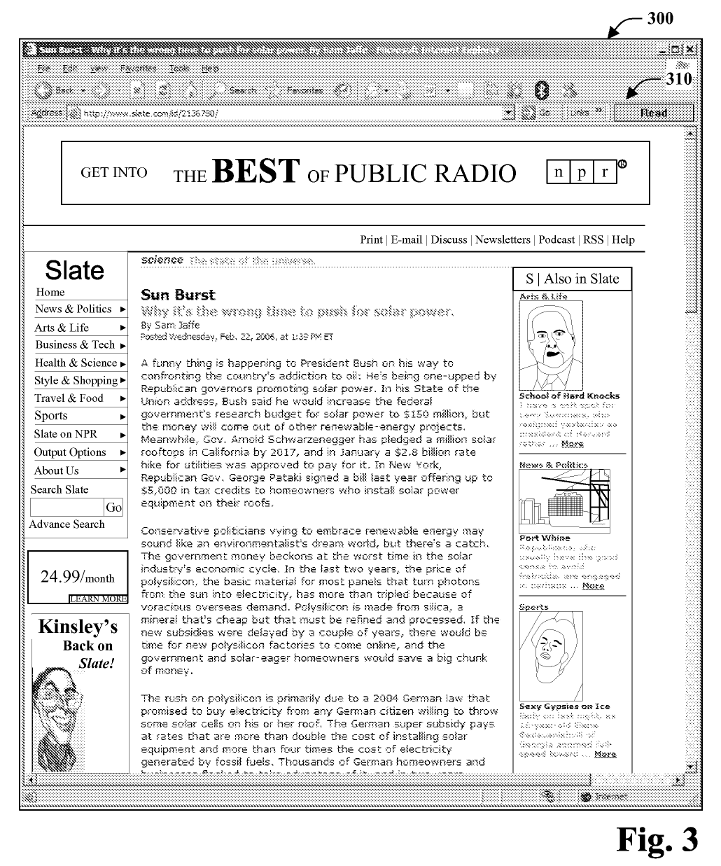

For purposes of clarity and understanding, consider exemplary screenshots 300, 400 and 500 provided in FIGS. 3, 4 and 5, respectively. While certain content display orientations are shown and described, those skilled in the art will recognize that various other alternatives can be employed. These pages/screens can be stored and/or transmitted as display descriptions (e.g., style documents), as graphical user interfaces (GUIs), or by other methods of presenting information on a device screen (e.g. personal computer, PDA, mobile telephone . . . ). The layout, information and/or content to be displayed can be stored in memory, database or other computer readable medium or storage facility prior to presentation.

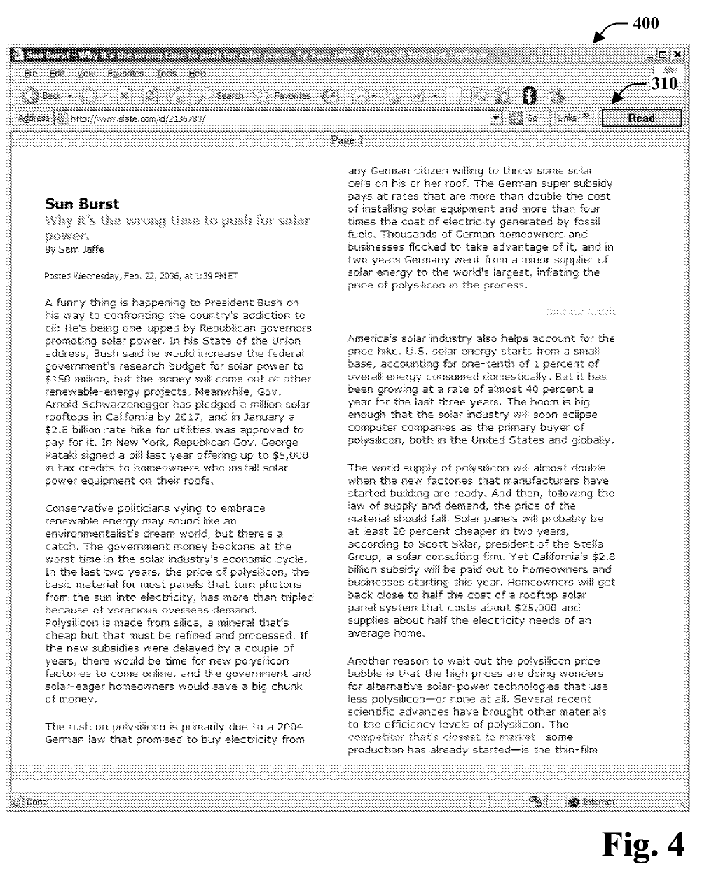

Referring first to FIG. 3, exemplary screenshot 300 is illustrated in accordance with an aspect of the subject innovation. Screenshot 300 depicts the manner in which content is presented by a conventional web browser. As shown, an article entitled “Sun Burst” is presented in the center surrounded by graphics, navigational tabs, advertisements, and links to other articles, among other things. Only a portion of the article can be viewed initially. To view the remainder, users must remember where they left off reading, scroll down a bit, locate where they previously stopped reading and continue this process until they either finish reading or lose interest in proceeding. Unlike conventional browsers, however, the exemplary browser includes a button 310 labeled “Read” within the toolbar. Upon selection of the button 310, the layout of the content can be modified in accordance with one or more aspects of the innovation, as shown in FIG. 4.

FIG. 4 illustrates an exemplary screenshot 400 that can be generated by the modification system 100 of the subject innovation. As depicted, the text of the article as been reformatted into two columns and all surrounding graphics removed. In this manner, more of the article is displayed than in the original screenshot 300. Furthermore, the article has been paginated. The first page is shown. Subsequent pages can be viewed by selecting the button 310 again, selecting forward or backward icons (not shown), pressing the PageUp or PageDown keys, and/or clicking on a link within the text. Furthermore, while screenshot 400 does not provide a vertical scroll bar, one can be included to allow flipping between pages, and more than one page can be displayed at a time.

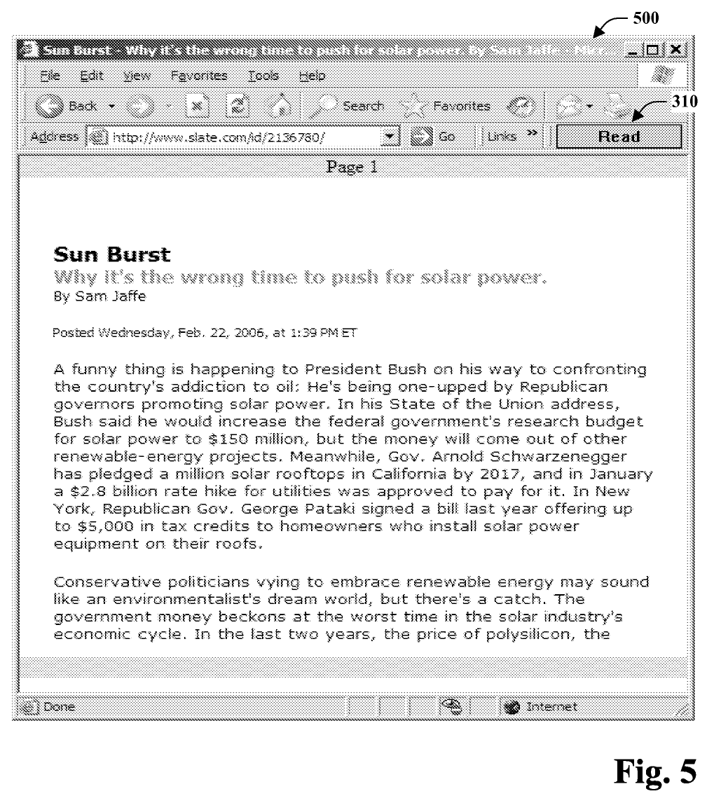

The manner in which a layout is modified can be dependent upon context information such as the size of a browser window. Screenshots 300 and 400 have the same size window. FIG. 5 depicts an exemplary screenshot 500 with a smaller window. For example, this screenshot can be associated with a device with a smaller viewable area or simply a window reduced in size. In this case, the system 100 removes all surrounding graphics and chooses to display only a single column rather than multiple columns as the text size would otherwise be difficult to read. The layout is further paginated to allow a user to page through text more efficiently than scrolling. It should be appreciated that different window sizes can therefore influence the layout such that readability is optimized.

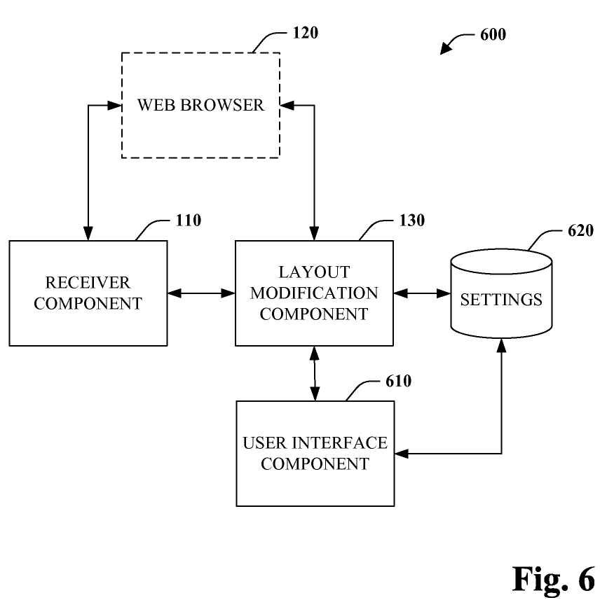

FIG. 6 depicts a layout modification system 600 in accordance with an aspect of the subject innovation. Similar to system 100 of FIG. 1, system 600 includes a receiver component 110 that acquires content data from web browser 120, for instance, and provides it to layout modification component 130. Component 130 alters the layout of the content, for instance to improve readability, and provides it back to the web browser 120 for display. Additionally, system 600 includes a user interface component 610 communicatively coupled to layout modification component 130 and settings store 620. The user interface component 610 provides a mechanism to facilitate user interaction with the modification system 600. In one exemplary implementation, the user interface component 610 can be a graphical user interface (GUI) set up to allow easy and intuitive interaction.

In one instance, the user interface component 610 can be employed to select content. For example, a user can select an HTML (Hyper Text Markup Language) stream they want to read, which is then modified or re-laid out employing specific settings. The re-layout can take place in the entire browser window or in parts thereof. For example, if selected text is displayed only in a vertical middle third of the page, it can be paginated solely within this middle third of the page. The user interface component 610 can also facilitate identification of settings and/or preferences.

In particular, interface component 610 can interact with settings store 620 to facilitate persistence, retrieval and/or modification of layout settings. The layout modification component 130 can then employ these settings when modifying a layout. For example, such settings can include but are not limited text properties such as font face, size and background color and/or layout preferences such as column width, margin size and line space, among other things.

Further yet, a user can persist settings in store 620 regarding specific styles to associate with a particular web page or layout. The settings can be stored in a style document, which can be utilized to interpret/modify associated content layout. These settings can be applied by default when the user is viewing content coming from a particular site or when content is laid out in particular manner, such as when tables are used to achieve precise positioning and the content of interest is located in a particular table location (e.g., center cell of the second row).

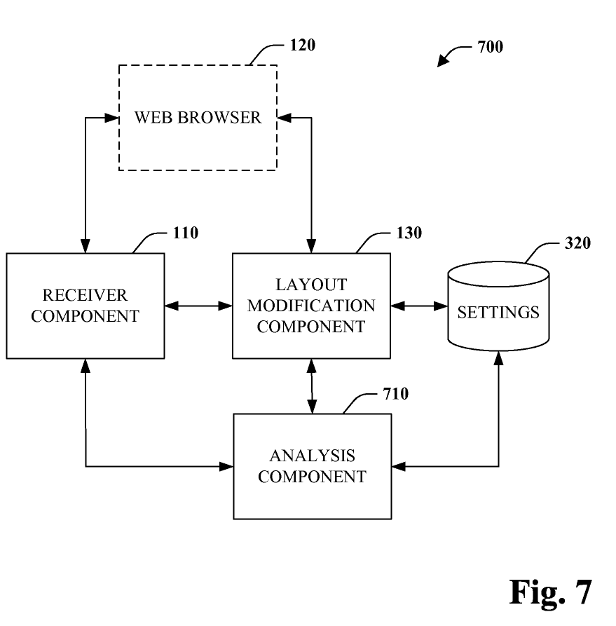

FIG. 7 is a web page modification system 700 including an analysis component 710 in accordance with an aspect of the subject innovation. Similar to systems 100 and 600 (FIGS. 1 and 6, respectively), system 700 includes a receiver component 110, web browser component 120, and layout modification system 130, as previously described. System 700 also includes a settings store component 620 that houses information pertaining to layout modification. Still further yet, the system 700 includes an analysis component 710 communicatively coupled to the receiver component 110, the layout modification component 130 and settings store 620. The analysis component 710 is operable to analyze an incoming flow and facilitate optimized modification for a particular context (e.g., goal, task . . . ). In particular, the analysis component 710 can identify particular portions of a content and/or layout thereof that are relevant to a particular task and initiate modification thereof with appropriate layout techniques to facilitate the task. For example, the analysis component 710 can receive incoming content associated with a web page and provide optimized settings to layout modification component 110 to optimize reading of that content. The settings can be associated with all or a portion of the content such as portions of long streams of text. More specifically, setting store 620 can include a myriad of settings associated with different types of layouts and analysis component can match the received content to a particular group of settings that it will then provide to the layout modification component 130 for use in re-laying out the content in a more reader friendly manner.

It is to be noted that the analysis component 710 can also work in conjunction with the user interface component 610 of FIG. 6. For example, a user can create and/or alter the settings that are associated with particular types of content or layouts. Accordingly, the next time such content or layouts are detected the altered settings can be employed to modify the layout.

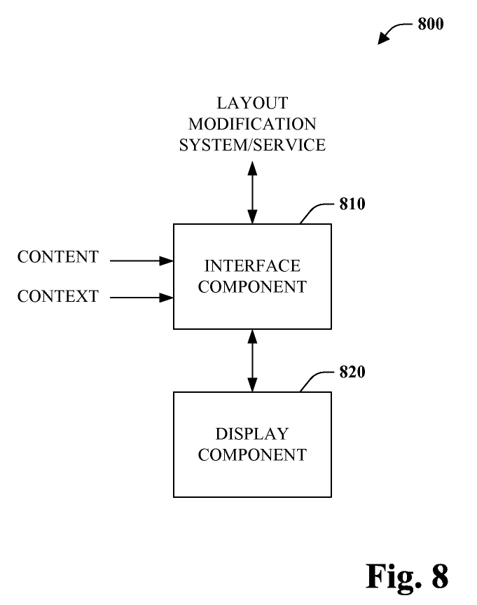

Referring to FIG. 8, a layout system 800 is illustrated in accordance with an aspect of the innovation. System 800 includes interface component 810 and display component 820. The interface component 810 (e.g., application programming interface API) can receive, retrieve or otherwise obtain data such as web content as well as context information (e.g., display size . . . ) and transmit such received information to a layout modification system or service. Based at least in part of the provided information, a suggested/recommended layout can be supplied to the interface component 810 by the system or service. This layout can then be transmitted or otherwise accessed by the display component 820, which can subsequently or concurrently render or display content in accordance with an associated layout. In this embodiment, an application, such as a web browser, need not include all functionality required to re-layout content but rather can communicate with system or service (e.g., external, third-party . . . ). This can serve to improve availability over multiple user devices, among other things. For example, a user can set preferences regarding layout of particular web page content on a first device and save them externally, for instance utilizing the interface component 810. Subsequently, these preferences can be applied to re-layout content on at least a second device communicatively coupled to the system/service via the interface component 810. It should be appreciated that all previous and subsequently described functionality can be employed with respect to system 800 utilizing at least interface component 810 to facilitate communication with the modification system/service.

The aforementioned systems have been described with respect to interaction between several components. It should be appreciated that such systems and components can include those components or sub-components specified therein, some of the specified components or sub-components, and/or additional components. Sub-components could also be implemented as components communicatively coupled to other components rather than included within parent components. Further yet, one or more components and/or sub-components may be combined into a single component providing aggregate functionality. The components may also interact with one or more other components not specifically described herein for the sake of brevity, but known by those of skill in the art.

Furthermore, as will be appreciated, various portions of the disclosed systems above and methods below may include or consist of artificial intelligence, machine learning, or knowledge or rule based components, sub-components, processes, means, methodologies, or mechanisms (e.g., support vector machines, neural networks, expert systems, Bayesian belief networks, fuzzy logic, data fusion engines, classifiers . . . ). Such components, inter alia, can automate certain mechanisms or processes performed thereby to make portions of the systems and methods more adaptive as well as efficient and intelligent. By way of example and not limitation, analysis component 610 can employ such mechanisms to facilitate identifying content and/or layouts and/or desirable settings for modification of web content. For instance, analysis component 610 can learn or infer (as the term is defined herein) how specific users desire particular content to be laid out based on historical user interaction. In this manner, content can be re-laid out automatically and intelligently.

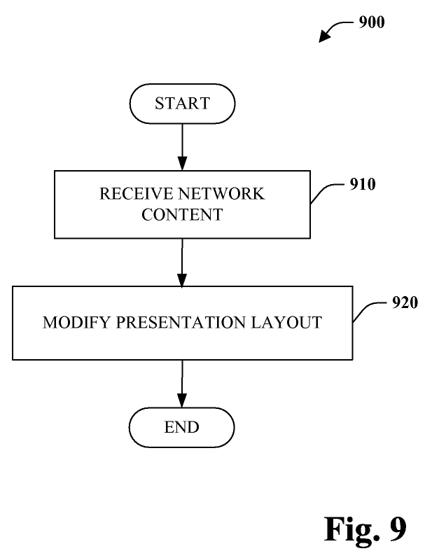

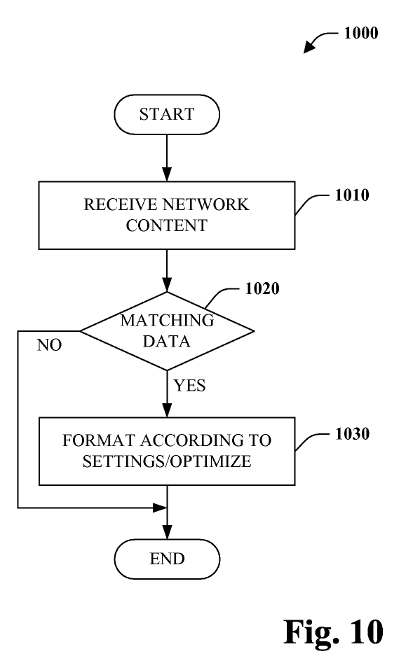

In view of the exemplary systems described supra, methodologies that may be implemented in accordance with the disclosed subject matter will be better appreciated with reference to the flow charts of FIGS. 9 and 10. While for purposes of simplicity of explanation, the methodologies are shown and described as a series of blocks, it is to be understood and appreciated that the claimed subject matter is not limited by the order of the blocks, as some blocks may occur in different orders and/or concurrently with other blocks from what is depicted and described herein. Moreover, not all illustrated blocks may be required to implement the methodologies described hereinafter.

Additionally, it should be further appreciated that the methodologies disclosed hereinafter and throughout this specification are capable of being stored on an article of manufacture to facilitate transporting and transferring such methodologies to computers. The term article of manufacture, as used herein, is intended to encompass a computer program accessible from any computer-readable device, carrier or media.

Turning attention to FIG. 9, a re-layout method 900 is illustrated in accordance with an aspect of the subject innovation. At reference numeral 910, network content is received from an application such as a browser. This data can include text, graphics, sound, multimedia and the like as provided by a webpage, for instance, for presentation. At numeral 920, the layout of the content is modified in accordance with a task or goal, for instance to improve readability. In general, the layout can be divided into discrete areas wherein particular content is shown or hidden and/or afforded in such a manner that facilitates sequential and/or non-sequential navigation, among other things. By way of example, text and graphics can be laid out in multiple columns, paginated and/or text style altered. Given a long steam of text, typographical and/or layout properties can be adjusted to enhance readability by removing some or all irrelevant graphics (e.g., advertisements), dividing text into pages and/or formatting page text into columns. In the case of a browser, the re-laid out content can be presented in the same browser window or in a new window or web page.

FIG. 10 depicts an automated layout modification methodology 1000 in accordance with an aspect of the subject innovation. At reference numeral 1010, network content (e.g. HTML) is received, retrieved or otherwise obtained. At numeral 920, a determination is made as to whether the content or layout thereof matches a group of one or more settings or preferences. These settings can be provided by a user, preprogrammed and/or automatically inferred to accomplish a goal such as to enhance readability. If the data or layout does not match, the method 1000 can simply terminate. Alternatively, the method 1000 can proceed to loop back to 1010 to continuously check if there is a match (not shown). If there is match at 1020, the content is formatted in accordance with the settings and the method 1000 terminates. By way of example, a content style document can be retrieved that designates a specific layout, for instance via a set of rules, instructions and/or patterns. The style document can then be applied to the content to perform the re-layout.

It should be noted that while described for purpose of clarity with respect to web content and browser 120, the scope of the innovation is not so limited. The innovation can also be easily extended with respect to other network technologies, viewers and the like. Consider for example, electronic mail or email. It such a scenario, the receiver component 110 and layout modification component 130 of FIG. 1 can interact with an email application in a similar manner in which they interact with a web browser 120. Accordingly, a lengthy email message may be divided into columns and/or paginated by layout modification component 130 to facilitate readability. Other aspects of the described innovation can also be applied to alternate technologies, such as email, details of which are omitted for purposes of brevity.

Furthermore, re-layout or layout modification can be performed with respect to any goal or task not limited to improving readability. For example, a user of a search engine may desire to view only advertisements rather than both links and advertisements for a set of one or more keywords. In accordance with the goal, one or more preferences can be set that filter out links for all or select searches. As a result, search results can returned and laid out displaying solely advertisements in a particular format. Various other re-layout applications are possible and will be become apparent to one of skill in the art upon reading this detailed description. These other applications are omitted for purposes of brevity and clarity, but nevertheless are to be deemed within the spirit and scope of the innovation.

As used in this application, the terms “component” and “system” and the like are intended to refer to a computer-related entity, either hardware, a combination of hardware and software, software, or software in execution. For example, a component may be, but is not limited to being, a process running on a processor, a processor, an object, an instance, an executable, a thread of execution, a program, and/or a computer. By way of illustration, both an application running on a computer and the computer can be a component. One or more components may reside within a process and/or thread of execution and a component may be localized on one computer and/or distributed between two or more computers.

The word “exemplary” is used herein to mean serving as an example, instance, or illustration. Any aspect or design described herein as “exemplary” is not necessarily to be construed as preferred or advantageous over other aspects or designs. Similarly, examples are provided herein solely for purposes of clarity and understanding and are not meant to limit the subject innovation or portion thereof in any manner. It is to be appreciated that a myriad of additional or alternate examples could have been presented, but have been omitted for purposes of brevity.

Artificial intelligence based systems (e.g. explicitly and/or implicitly trained classifiers) can be employed in connection with performing inference and/or probabilistic determinations and/or statistical-based determinations as in accordance with one or more aspects of the subject innovation as described hereinafter. As used herein, the term “inference” or “infer” refers generally to the process of reasoning about or inferring states of the system, environment, and/or user from a set of observations as captured via events and/or data. Inference can be employed to identify a specific context or action, or can generate a probability distribution over states, for example. The inference can be probabilistic—that is, the computation of a probability distribution over states of interest based on a consideration of data and events. Inference can also refer to techniques employed for composing higher-level events from a set of events and/or data. Such inference results in the construction of new events or actions from a set of observed events and/or stored event data, whether or not the events are correlated in close temporal proximity, and whether the events and data come from one or several event and data sources. Various classification schemes and/or systems (e.g., support vector machines, neural networks, expert systems, Bayesian belief networks, fuzzy logic, data fusion engines . . . ) can be employed in connection with performing automatic and/or inferred action in connection with the subject innovation.

Furthermore, all or portions of the subject innovation may be implemented as a method, apparatus, or article of manufacture using standard programming and/or engineering techniques to produce software, firmware, hardware, or any combination thereof to control a computer to implement the disclosed innovation. The term “article of manufacture” as used herein is intended to encompass a computer program accessible from any computer-readable device, carrier, or media. For example, computer readable media can include but are not limited to magnetic storage devices (e.g., hard disk, floppy disk, magnetic strips . . . optical disks (e.g., compact disk (CD), digital versatile disk (DVD). . . ), smart cards, and flash memory devices (e.g. card, stick, key drive . . . ). Additionally, it should be appreciated that a carrier wave can be employed to carry computer-readable electronic data such as those used in transmitting and receiving electronic mail or in accessing a network such as the Internet or a local area network (LAN). Of course, those skilled in the art will recognize many modifications may be made to this configuration without departing from the scope or spirit of the claimed subject matter.

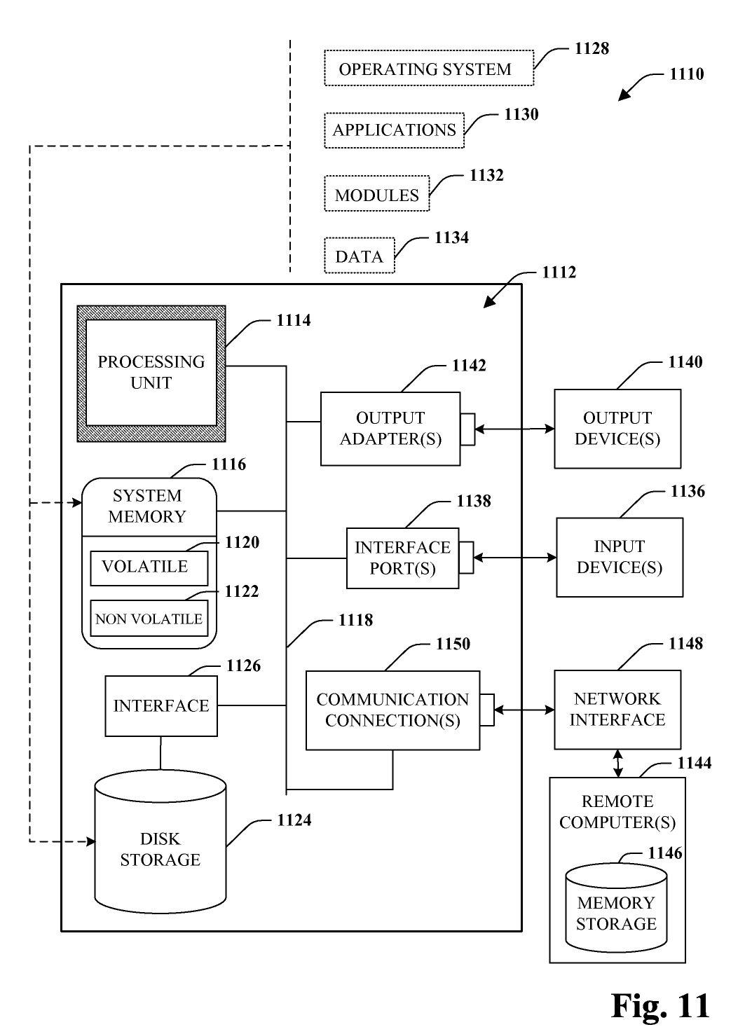

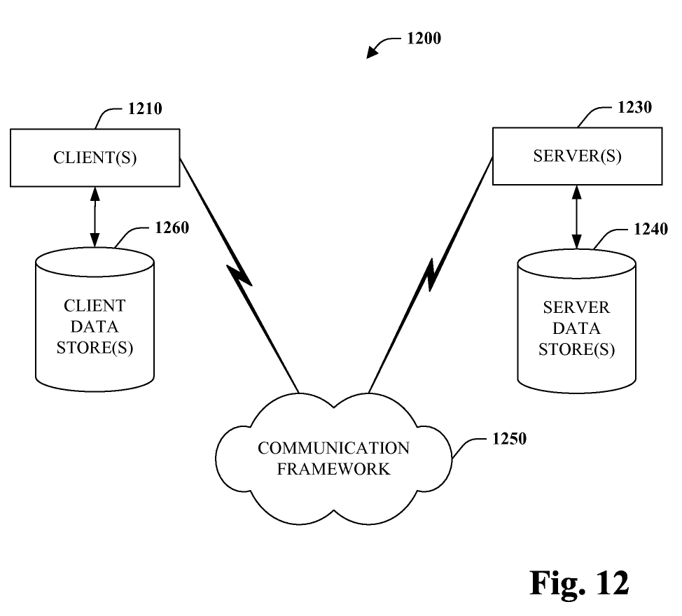

In order to provide a context for the various aspects of the disclosed subject matter, FIGS. 11 and 12 as well as the following discussion are intended to provide a brief, general description of a suitable environment in which the various aspects of the disclosed subject matter may be implemented. While the subject matter has been described above in the general context of computer-executable instructions of a computer program that runs on a computer and/or computers, those skilled in the art will recognize that the subject innovation also may be implemented in combination with other program modules. Generally, program modules include routines, programs, components, data structures, etc. that perform particular tasks and/or implement particular abstract data types. Moreover, those skilled in the art will appreciate that the inventive methods may be practiced with other computer system configurations, including single-processor or multiprocessor computer systems, minicomputing devices, mainframe computers, as well as personal computers, hand-held computing devices (e.g., personal digital assistant (PDA), phone, watch . . . ), microprocessor-based or programmable consumer or industrial electronics, and the like. The illustrated aspects may also be practiced in distributed computing environments where tasks are performed by remote processing devices that are linked through a communications network. However, some, if not all aspects of the claimed innovation can be practiced on stand-alone computers. In a distributed computing environment, program modules may be located in both local and remote memory storage devices.

With reference to FIG. 11, an exemplary environment 1110 for implementing various aspects disclosed herein includes a computer 1112 (e.g., desktop, laptop, server, hand held, programmable consumer or industrial electronics . . . ). The computer 1112 includes a processing unit 1114, a system memory 1116, and a system bus 1118. The system bus 1118 couples system components including, but not limited to, the system memory 1116 to the processing unit 1114. The processing unit 1114 can be any of various available microprocessors. Dual microprocessors and/or other multiprocessor architectures such as multi-core can also be employed as the processing unit 1114. The system bus 1118 can be any of several types of bus structure(s) including the memory bus or memory controller, a peripheral bus or external bus, and/or a local bus using any variety of available bus architectures.

The system memory 1116 includes volatile memory 1120 and nonvolatile memory 1122. The basic input/output system (BIOS), containing the basic routines to transfer information between elements within the computer 1112, such as during start-up, is stored in nonvolatile memory 1122.

Computer 1112 also includes removable/non-removable, volatile/nonvolatile computer storage media. FIG. 11 illustrates, for example, disk storage 1124. Disk storage 1124 includes, but is not limited to, devices like a magnetic disk drive, floppy disk drive, tape drive, Jaz drive, Zip drive, LS-100 drive, flash memory card, or memory stick. In addition, disk storage 1124 can include storage media separately or in combination with other storage media including, but not limited to, an optical disk drive. To facilitate connection of the disk storage devices 1124 to the system bus 1118, a removable or non-removable interface is typically used such as interface 1126.

It is to be appreciated that FIG. 11 describes software that acts as an intermediary between users and the basic computer resources described in suitable operating environment 1110. Such software includes an operating system 1128. Operating system 1128, which can be stored on disk storage 1124, acts to control and allocate resources of the computer system 1112. System applications 1130 take advantage of the management of resources by operating system 1128 through program modules 1132 and program data 1134 stored either in system memory 1116 or on disk storage 1124. It is to be appreciated that the subject innovation can be implemented with various operating systems or combinations of operating systems.

A user enters commands or information into the computer 1112 through input device(s) 1136. Input devices 1136 include, but are not limited to, a pointing device such as a mouse, trackball, stylus, touch pad, keyboard, microphone, joystick, game pad, satellite dish, scanner, TV tuner card, digital camera, digital video camera, web camera, and the like. These and other input devices connect to the processing unit 1114 through the system bus 1118 via interface port(s) 1138. Interface port(s) 1138 include, for example, a serial port, a parallel port, a game port, and a universal serial bus (USB). Output device(s) 1140 use some of the same type of ports as input device(s) 1136. Thus, for example, a USB port may be used to provide input to computer 1112 and to output information from computer 1112 to an output device 1140. Output adapter 1142 is provided to illustrate that there are some output devices 1140 like displays (e.g., flat panel and CRT), speakers, and printers, among other output devices 1140 that require special adapters. The output adapters 1142 include, by way of illustration and not limitation, video and sound cards that provide a means of connection between the output device 1140 and the system bus 1118. It should be noted that other devices and/or systems of devices provide both input and output capabilities such as remote computer(s) 1144.

Computer 1112 can operate in a networked environment using logical connections to one or more remote computers, such as remote computer(s) 1144. The remote computer(s) 1144 can be a personal computer, a server, a router, a network PC, a workstation, a microprocessor based appliance, a peer device or other common network node and the like, and typically includes many or all of the elements described relative to computer 1112. For purposes of brevity, only a memory storage device 1146 is illustrated with remote computer(s) 1144. Remote computer(s) 1144 is logically connected to computer 1112 through a network interface 1148 and then physically connected via communication connection 1150. Network interface 1148 encompasses communication networks such as local-area networks (LAN) and wide-area networks (WAN).

Communication connection(s) 1150 refers to the hardware/software employed to connect the network interface 1148 to the bus 1118. While communication connection 1150 is shown for illustrative clarity inside computer 1116, it can also be external to computer 1112. The hardware/software necessary for connection to the network interface 1148 includes, for exemplary purposes only, internal and external technologies such as, modems including regular telephone grade modems, cable modems, power modems and DSL modems, ISDN adapters, and Ethernet cards or components.

FIG. 12 is a schematic block diagram of a sample-computing environment 1200 with which the subject innovation can interact. The system 1200 includes one or more client(s) 1210. The client(s) 1210 can be hardware and/or software (e.g., threads, processes, computing devices). The system 1200 also includes one or more server(s) 1230. Thus, system 1200 can correspond to a two-tier client server model or a multi-tier model (e.g., client, middle tier server, data server), amongst other models. The server(s) 1230 can also be hardware and/or software (e.g., threads, processes, computing devices). The servers 1230 can house threads to perform transformations by employing the subject innovation, for example. One possible communication between a client 1210 and a server 1230 may be in the form of a data packet transmitted between two or more computer processes.

The system 1200 includes a communication framework 1250 that can be employed to facilitate communications between the client(s) 1210 and the server(s) 1230. The client(s) 1210 are operatively connected to one or more client data store(s) 1260 that can be employed to store information local to the client(s) 1210. Similarly, the server(s) 1230 are operatively connected to one or more server data store(s) 1240 that can be employed to store information local to the servers 1230.

What has been described above includes examples of aspects of the claimed subject matter. It is, of course, not possible to describe every conceivable combination of components or methodologies for purposes of describing the claimed subject matter, but one of ordinary skill in the art may recognize that many further combinations and permutations of the disclosed subject matter are possible. Accordingly, the disclosed subject matter is intended to embrace all such alterations, modifications and variations that fall within the spirit and scope of the appended claims. Furthermore, to the extent that the terms “includes,” “has” or “having” or variations in form thereof are used in either the detailed description or the claims, such terms are intended to be inclusive in a manner similar to the term “comprising” as “comprising” is interpreted when employed as a transitional word in a claim.

What is claimed is:

1. A layout modification system comprising the following computer-implemented components:
a receiver component that acquires network content with a designated layout; and
a modification component that modifies the layout to be presented to facilitate one or more specific tasks.

2. The system of claim 1, further comprising a component employed by the modification component that alters text style of the content.

3. The system of claim 1, further comprising a component employed by the modification component that paginates at least a portion of the content.

4. The system of claim 1, further comprising a structure component employed by the modification component that formats at least a portion of the content into a plurality of discrete areas.

5. The system of claim 1, further comprising an interface component that enables users to initiate and/or control layout modification.

6. The system of claim 1, further comprising an analysis component identifies at least a portion of the network content relevant to the one or more specific tasks and initiates modification thereof with particular layout techniques.

7. The system of claim 1, the receiver and modification components form a part of a browser plug-in and/or toolbar.

8. The system of claim 1, the receiver and modification components are one or more programmatic scripts embedded in a web page.

9. The system of claim 8, the one or more programmatic scripts are injected into the web page by at least one of a user, page author, and third party service.

10. The system of claim 1, the content is acquired from a web browser.

11. The system of claim 1, the content is acquired from an electronic mail application.

12. A method of modifying web page presentation, comprising the following computer-implemented acts:
obtaining web page content; and
augmenting at least a portion of the web page layout to enhance readability including paginating at least a portion of the content.

13. The method of claim 12, augmenting the layout further comprises modifying text styles.

14. The method of claim 12, augmenting the layout further comprises dividing at least a portion of the content into disparate layout regions.

15. The method of claim 12, augmenting the layout further comprises dividing the content into distinct areas and modifying text styles.

16. The method of claim 12, further comprising generating another web page including the modified layout.

17. The method of claim 12, further comprising receiving display context and reinitiating augmentation based on an altered context.

18. The method of claim 12, further comprising receiving user input designating content to be augmented.

19. The method of claim 12, further comprising accessing a content style document and augmenting the layout in accordance with the document.

20. A web browser system comprising:
a computer-implemented for providing web page content to a component that identifies a layout that improves readability via pagination and columnation; and
a computer-implemented means for rendering the content with the identified layout.
